(19) United States
(12) Patent Application Publication
(10) Pub. No.: US 2014/0042289 A1
(43) Pub. Date: Feb. 13, 2014

(54) SLIDE RAIL DEVICE FOR VEHICLE

(71) Applicant: SHIROKI CORPORATION, Kanagawa (JP)

(72) Inventor: Yukinori KAWANO, Kanagawa (JP)

(73) Assignee: SHIROKI CORPORATION, Kanagawa (JP)

(21) Appl. No.: 13/963,064

(22) Filed: Aug. 9, 2013

(30) Foreign Application Priority Data
Aug. 13, 2012 (JP) 2012-179195

(51) Int. Cl. B60N 2/08

(52) U.S. Cl. CPC B60N 2/0818
USPC 248/429

(57) ABSTRACT

A slide rail device for a vehicle includes a lower rail immovable relative to a vehicle floor, an upper rail slidably supported by the lower rail in the forward/rearward direction, a locking mechanism which restricts and releases a sliding movement of the upper rail, a lock release lever provided in an internal space of the upper rail and rotatable between a locked position at which the locking mechanism can restrict the slidable movement of the upper rail, and an unlocked position at which the restriction of this slidable movement is released, a connecting end portion formed on the front end of the lock release lever and positioned above a portion of the lock release lever that is in the internal space of the upper rail or at one side of the lower rail, and a handle connected to the connecting end portion.

### BACKGROUND OF THE INVENTION

1. Field of the Invention

The present invention relates to a slide rail device, for a vehicle, which supports a seat in a slidable manner.

2. Description of Related Art

A slide rail device for vehicle is, in general, equipped with a pair of left and right lower rails which extend in the forward/rearward direction and are fixed to a vehicle interior floor, and each have a channel structure with the upper side thereof open; and a pair of left and right upper rails which support a seating portion of a seat, (part of the left and right upper rails) are slidably supported in an inner space of the left and right lower rails, and each have a channel structure with the underside thereof open. A large number of lock grooves, arranged in the forward/rearward direction, are formed on each lower rail. Furthermore, each upper rail is provided with a lock member which disengageably engages with some of the lock grooves, and a lock-release lever which is rotatable about an axis extending in the leftward/rightward direction. The lock-release lever is rotatable in an upward/downward direction between a locked position, at which the lock member is engaged with some of the lock grooves, and an unlocked position, at which the lock member is disengaged from the lock grooves; the lock-release lever is biased toward the locked position by a biaser. Furthermore, an end portion of a handle is connected to the front end of the lock-release lever.

When the lock-release lever is positioned at the locked position, since the lock member engages with the lock grooves, the sliding of the upper rail relative to the lower rail is restricted (prevented). On the other hand, upon a passenger rotating the lock-release levers to the unlock position, the lock member disengages from the lock grooves to thereby allow the upper rails to slide with respect to the lower rails.

Examples of the related art of such a type of slide rail device for a vehicle are disclosed in Japanese Unexamined Patent Publication Nos. 2003-252086 and 2004-276670.

In the slide rail device, for a vehicle, of the above-mentioned Japanese Unexamined Patent Publication No. 2003-252086, the entire lock-release lever (leaf spring) is positioned in the internal space of the upper rail, and a rear end portion of a handle (operational lever) is connected to the front end portion of the lock-release lever at the internal space of the upper rail.

On the other hand, in the slide rail device, for a vehicle, of the above-mentioned Japanese Unexamined Patent Publication No. 2004-276670, the rear portion of the lock-release lever (lever holder) is positioned in the internal space of the upper rail, and the front end portion of the lock-release lever projects upwardly from the upper rail through a through-hole formed in the upper surface of the upper rail. Furthermore, at the upper part of the upper rail (and the lower rail), the rear end of a handle is connected to the front end of the lock-release lever.

Generally, a lower rail and a vehicle floor surface are mutually fixed to each other by inserting a threaded part of a bolt through a through-hole formed in a base surface of the lower rail from the internal space (upper side) of the lower rail, screw engaging the threaded part of the bolt into a female hole (of a welded nut, etc.) formed on the vehicle floor, and abutting the head of the bolt against the undersurface of the lower rail.

In the slide rail device, for a vehicle, disclosed in the above-mentioned Japanese Unexamined Patent Publication No. 2003-252086, the entire lock-release lever (leaf spring) is positioned in the internal space of the upper rail, and moreover, the front end portion of the lock-release lever (the connecting part between the lock-release lever and the handle) is positioned at the same height as the rear portion of the lock-release lever. Accordingly, when applying the technical idea of the above-mentioned Japanese Unexamined Patent Publication No. 2003-252086 to a slide rail device in which the lower rail thereof is mounted to a vehicle floor by bolts, when the upper rail is slided relative to the lower rail, there is a risk of the rear end portion of the handle (and the front end portion of the lock-release lever) contacting the heads of the bolts that are positioned in the internal space (on the upper surface of the base surface) of the lower rail.

Furthermore, in order to achieve a secure locking/unlocking operation, it is necessary to move the lock member in the upward/downward direction by a large amount relative to the lock grooves, and accordingly, it is necessary to set a large rotational angle for the handle (for rotatably moving the lock-release lever between the locked position to and unlocked position). However, if the rotational angle of the handle disclosed in the above-mentioned Japanese Unexamined Patent Publication No. 2003-252086 is set at a large angle, when the front end portion of the handle is rotated upward in order to carry out a lock-release operation, since there is a risk of the rear end portion of the handle contacting the base surface of the lower rail due to the rear end portion of the handle moving downward by a large amount, it is difficult to achieve a secure locking/unlocking operation.

Whereas, in the slide rail device, for a vehicle, disclosed in the above-mentioned Japanese Unexamined Patent Publication No. 2004-276670, the rear end portion of the handle (and the front part of the lock-release lever) is positioned above the lower rail. Accordingly, even if the technical concept of the above-mentioned Japanese Unexamined Patent Publication No. 2004-276670 were to be applied to a slide rail device, in which the lower rails are bolted (mounted) to a vehicle floor, there is no risk of the above-mentioned problems that occur in the case where the technical concept of the above-mentioned Japanese Unexamined Patent Publication No. 2003-252086 is applied.

However, in the slide rail device, for a vehicle, of the above-mentioned Japanese Unexamined Patent Publication No. 2004-276670, since a through-hole is formed in the upper surface of each upper rail, the mechanical strength of the upper rail is reduced.

### SUMMARY OF THE INVENTION

The present invention provides a slide rail device, for a vehicle, in which, when the upper rail is slidably moved along the lower rail in the forward/rearward direction, the risk of the handle contacting a mounted object that is mounted onto the base surface of a lower rail is low, and the risk of the rear end portion of the handle contacting the base surface of the lower rail is low while the mechanical strength of the upper rail is not reduced even in the case where the downward rotational amount of the rear end portion of the handle is set at a large amount during a locking/unlocking operation.

A slide rail device for vehicle according to the present invention includes a lower rail which extends in a forward/rearward direction and is formed as a channel member that is open at the upper side thereof, the lower rail being immovable relative to a floor of the vehicle; an upper rail which is formed as a channel member that is open at the lower side thereof, the upper rail being supported by the lower rail to be slidably movable relative to the lower rail in the forward/rearward direction; a locking mechanism provided between the upper rail and the lower rail, wherein the locking mechanism one of restricts and releases a restriction of a sliding movement of the upper rail relative to the lower rail; a lock release lever, provided in an internal space of the upper rail, which is upwardly/downwardly rotatable between a locked position at which the locking mechanism is allowed to restrict the slidable movement of the upper rail relative to the lower rail, and an unlocked position at which the restriction of the slidable movement of the upper rail relative to the lower rail is released, wherein a front end portion of the lock release lever is positioned further forward than a front end of the upper rail; a connecting end portion formed on the front end portion of the lock release lever, wherein the connecting end portion is positioned one of above a portion of the lock release lever that is in the internal space of the upper rail and at one side of the lower rail; and a handle, wherein an end portion of which is connected to the connecting end portion.

In the slide rail device, for a vehicle, according to the present invention, the front end portion of the lock-release lever is positioned further forward from the front end of the upper rail, and furthermore, the connecting end portion formed on the front end portion of the lock-release lever is positioned either above a portion of the lock-release lever that is positioned in the internal space of the upper rail, or positioned at one side of the lower rail.

In the case where the connecting end portion is positioned above the region positioned in the internal space of the lock-release lever, when the upper rail is slidably moved along the lower rail in the forward/rearward direction, the risk of the handle (and the connecting end portion of the lock-release lever) contacting a mounted object that is mounted onto the base surface of a lower rail is reduced. Furthermore, even in the case where the downward rotational amount of the rear end portion of the handle is set at a large amount during a locking/unlocking operation, since the risk of the rear end portion of the handle contacting the base surface of the lower rail is low, it is easy to achieve a secure locking/unlocking operation.

Whereas, if the connecting end portion of the lock-release lever is positioned at the side of the lower rail, when the upper rail is slidably moved along the lower rail in the forward/rearward direction, the risk of the handle (and the connecting end portion of the lock-release lever) contacting a mounted object that is mounted onto the base surface of a lower rail can be removed, and the risk of the rear end portion of the handle, that is set at a large downward rotational amount, contacting the base surface of the lower rail can also be removed.

Moreover, whether the connecting end portion is positioned above the region positioned in the internal space of the lock-release lever or positioned on a side of the lower rail, since there is no need to form a through-hole through the upper rail, no mechanical loss in strength is incurred.

It is desirable for at least part of the connecting end portion that is positioned at the region above the internal space of the lock release lever to be positioned above an upper surface of the lower rail.

Accordingly, in the case where the connecting end portion is positioned above the region positioned in the internal space of the lock-release lever, when the upper rail is slidably moved along the lower rail in the forward/rearward direction, the risk of the handle (and the connecting end portion of the lock-release lever) contacting a mounted object that is mounted onto the base surface of a lower rail can be further reduced, and the risk of the rear end portion of the handle, the downward rotational amount thereof being set at a large amount, contacting the base surface of the lower rail can be further reduced.

It is desirable for the front end portion of the lock release lever to include an upper extension which extends upwardly along an inner surface of one side wall of the lower rail; a sideward extension which extends in a sideward direction from an upper end of the upward extension and is positioned directly above the one side wall; and the connecting end portion, the connecting end portion extending downwardly from an end portion of the sideward extension along an outer surface of the one side wall.

Accordingly, in the case where the connecting end portion is positioned at a side of the lower rail, the front end portion of the lock-release lever can be prevented from increasing in size in the leftward/rightward direction and the upward/downward direction.

It is desirable for the lock release lever to be an integrally molded member.

Accordingly, the number of components/parts of the slide rail device, for a vehicle, and the manufacturing cost thereof can be reduced.

The present disclosure relates to subject matter contained in Japanese Patent Application No. 2012-179195 (filed on Aug. 13, 2012) which is expressly incorporated herein in its entirety.

### BRIEF DESCRIPTION OF DRAWINGS

FIG. 1 is a front perspective view of a first embodiment of the slide rail device, according to the present invention, viewed obliquely from above, in which the upper rails have been slided to the rear ends;

FIG. 2 is an exploded perspective view of the front of the slide rail device with the left rail unit omitted, viewed obliquely from above;

FIG. 3 is an exploded perspective view of the front of the slide rail device with the right rail unit omitted, viewed obliquely from below;

FIG. 4 is a cross sectional view taken along the line IV-IV shown in FIG. 1;

FIG. 5 is an exploded perspective view of a rail unit showing the lower rail in a longitudinal sectional view;

FIG. 6 is a front perspective view of the rail unit showing a cross sectional view of the lower rail, viewed obliquely from above;

FIG. 7 is a front perspective view of the upper rail, with a longitudinal section thereof cut-away, a lock-release lever, and a lock spring, viewed obliquely from below;

FIG. 8 is a schematic side elevational view showing states when the lock spring is positioned at the locked position and the unlocked position;

FIG. 9 is a side elevational view of the upper rail, the lock-release lever, a biasing spring and a loop handle when in a locked state, in which only the upper rail is shown as a longitudinal section view;

FIG. 10 is side elevational view similar to that of FIG. 9 when in an unlocked state;

FIG. 11 is a front perspective view of a second embodiment of the slide rail device, according to the present invention, viewed obliquely from above, in which the upper rails have been slided to the rear ends;

FIG. 12 is an exploded perspective view of the front of the slide rail device with the left rail unit omitted, viewed obliquely from above;

FIG. 13 is a front enlarged perspective view of the front-end portion of the lock-release lever and the handle connecting spring, viewed obliquely from above;

FIG. 14 is a front enlarged perspective view of the front end portion of the lock-release lever and one end portion of the loop handle, viewed obliquely from above; and

FIG. 15 is an enlarged front elevational view of the rail unit.

### DESCRIPTION OF EMBODIMENTS

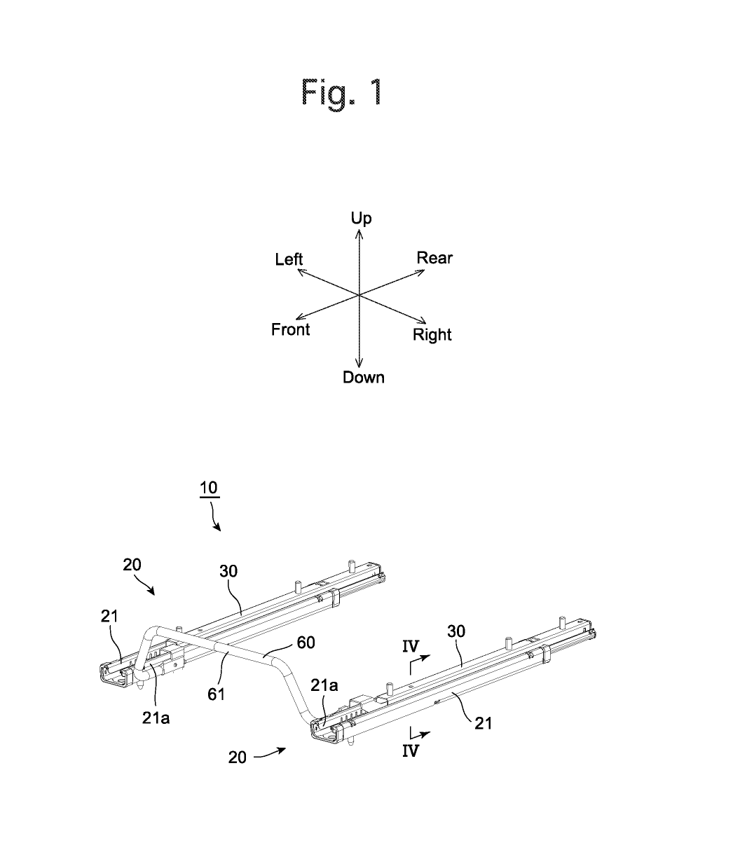

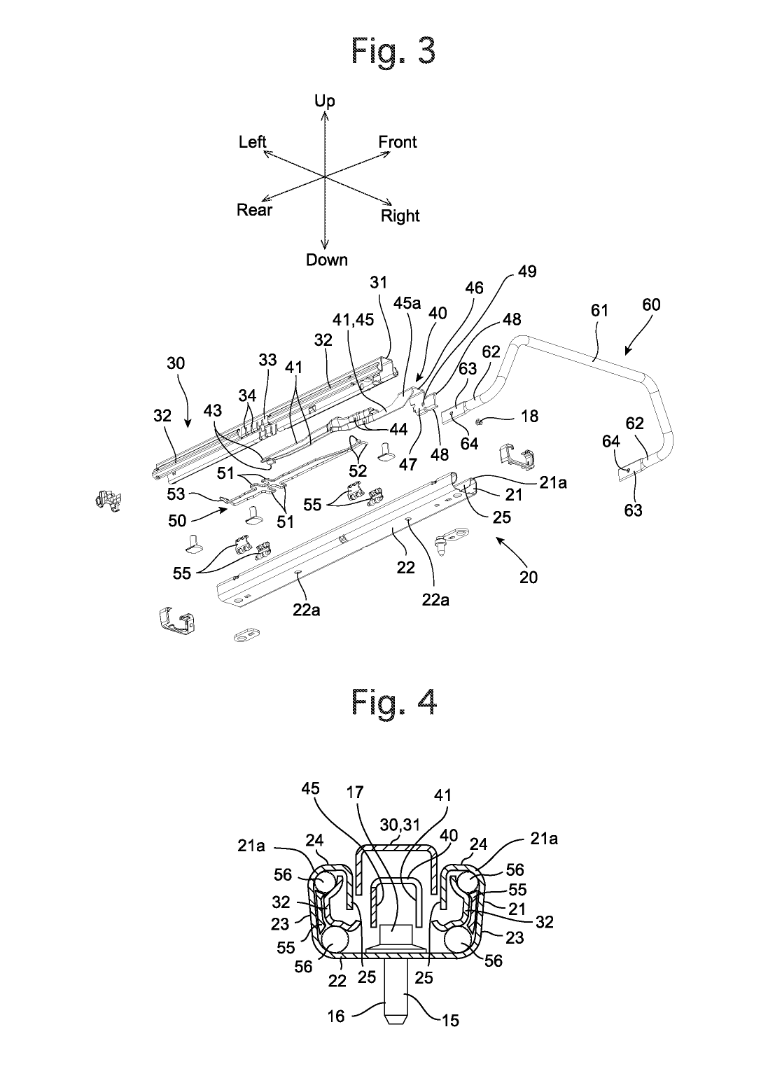

A first embodiment of the present invention will be hereinafter discussed with reference to FIGS. 1 through 10. Note that directions described in the following description are defined based on the directions of arrows shown in the drawings.

A slide rail device 10 is installed onto a vehicle interior floor of an automobile (vehicle) not shown in the drawings. A seat (not shown) is fixed to upper surfaces of the slide rail device 10 (upper rails 30).

The detailed structure of the slide rail device 10 will be discussed hereinafter.

The slide rail device 10 is provided, as large components thereof, with a pair of left and right rail units 20, and a loop handle 60 which connects the front ends of the left and right rail units 20. The left and right rail units 20 are mutually bilaterally-symmetrical while the loop handle 60 has a bilaterally-symmetrical shape, and hence, the slide rail device 10 is bilaterally symmetrical as a whole.

The left and right rail units 20 have the following structure.

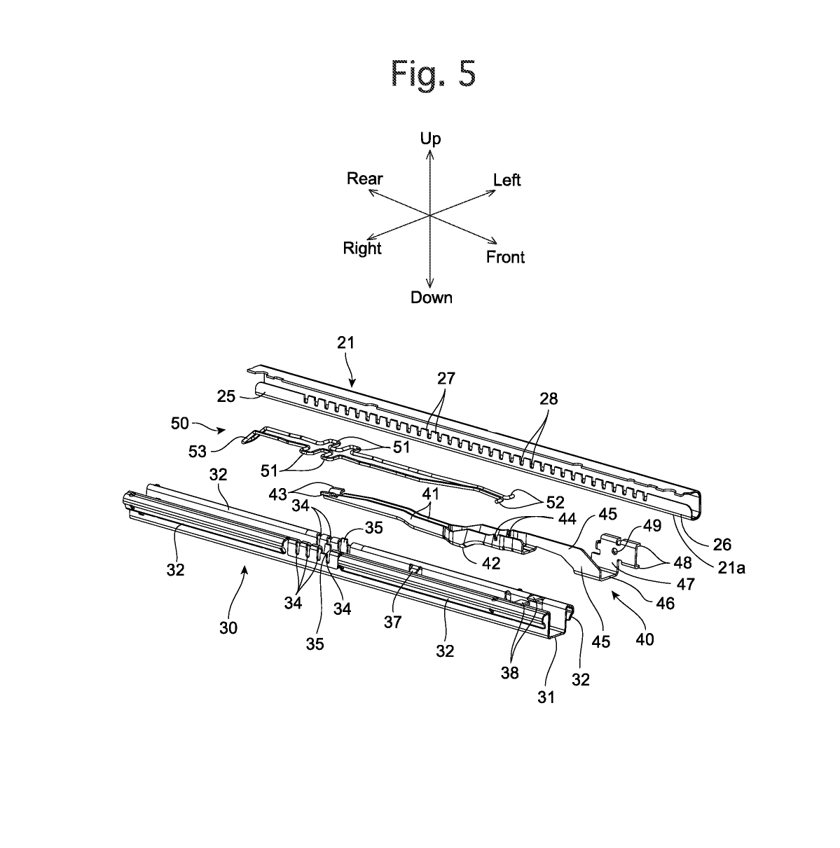

Each rail unit 20 is provided with a lower rail 21 which is mounted onto the vehicle interior floor. Each lower rail 21 is a metal channel member which extends in the forward/rearward direction and the top thereof is open, and is provided with a substantially-horizontal bottom wall 22, a pair of left and right outer wall portions 23 which extend upward from the left and right sides of the bottom wall 22, respectively, and pair of left and right roof underside portions 24 which extend inward from the top edges of the pair of left and right outer wall portions 23, respectively, and a pair of left and right inner wall portions (vertical walls) 25 which extend downwardly from the inner edges of the left and right roof underside portions 24. As shown in FIG. 5, etc., the upper edge portions of the left and right inner wall portions 25 (the portions connected to the roof underside portions 24) constitute base-end supporting portions 26 that extend in the forward/rearward direction. Furthermore, the left and right outer wall portions 23, the left and right roof underside portions 24, and the left and right inner wall portions 25 constitute left and right side walls 21a, respectively. Lower edge portions of the left and right inner wall portions 25 are provided with a large number of lock teeth 27, the upper ends thereof connecting with the base-end supporting portions 26, arranged at equal intervals in the forward/rearward direction. Lock grooves 28, the bottom ends of which are open, are formed between mutually adjacent lock teeth 27.

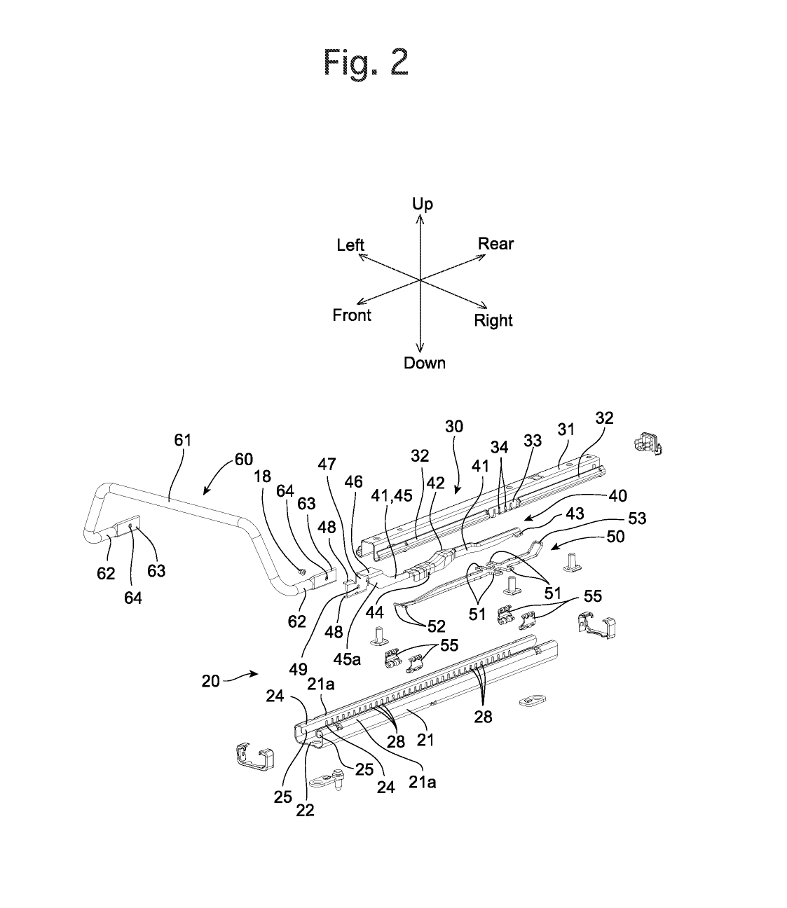

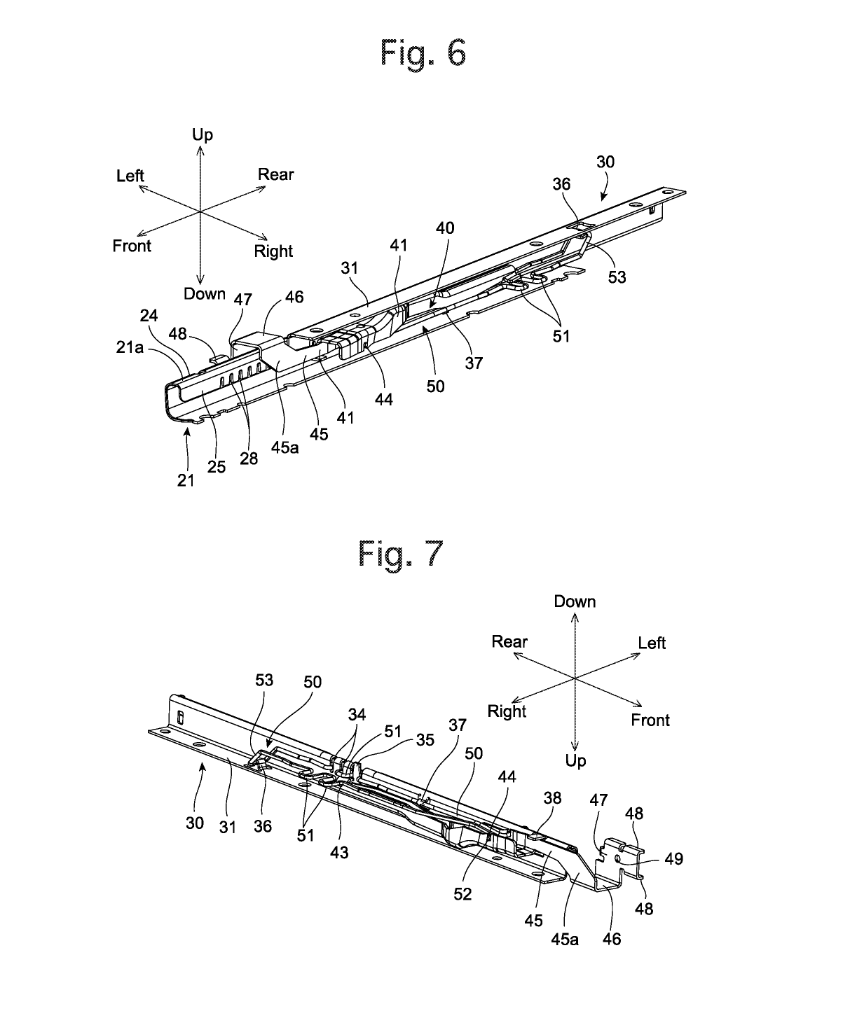

Each rail unit 20 is provided with an upper rail 30 that is slidable in the forward/rearward direction with respect to the associated lower rail 21. The upper rail 30 is a metal channel member which extends in the forward/rearward direction and the bottom thereof is open, and is provided with a base 31 having a substantially inverted U-shaped cross section, upright walls 32 which extend upward from lower end portions of the left and right side walls of the base 31, except central portions thereof in the longitudinal direction, and locking walls 33 which extend upward from the above-mentioned central portions of the side walls. As shown in FIGS. 2, 3, 5 and 8, etc., four forward/rearward movement restriction grooves 34 are formed over the lower edges of the left and right locking walls 33 and the lower edges of the side walls of the base 31 to extend upward. Furthermore, a downward restriction piece 35, which extends further downward than the lower edge of the forward/rearward movement restriction grooves 34, is integrally provided on a lower edge portion of the side wall portion of the base 31. In addition, as shown in FIGS. 6 and 7, etc., the base 31 is provided, in the vicinity of a central portion of the roof portion thereof, with a lock-engaging lug 36 which is formed by cutting and raising a portion of the base 31 to extend downward and rearward. Furthermore, inward-extending lock-engaging lugs 37, which are formed by cutting and raising portions of the left and right side wall portions of the base portion 31, are positioned slightly in front of central portions of the left and right side wall portions. Furthermore, substantially horizontal lower support portions 38, which project inwardly from the lower edges of the left and right side walls of the base 31, are integrally provided on the base 31 near the front end thereof.

Each rail unit 20 is further provided with a lock release lever 40 and a lock spring 50 which are installed in the associated upper rail 30.

The lock release lever 40 is an integrally press-molded member (channel member), formed from a metal plate, which extends in the forward/rearward direction and the bottom thereof is open, and is provided with a pair of left and right side walls 41. As shown in FIGS. 2, 5, 9 and 10, etc., a rotational contact protrusion 42 which extends in the leftward/rightward direction is provided on, and protrudes from, an upper surface of the lock release lever 40. In addition, a pair of left and right substantially horizontal spring pressing-pieces 43 are respectively provided on the rear end portion of the lock release lever 40, and upward-facing spring-hook grooves 44 in the lower edges of the front portions (the portions positioned forward from the rotational contact protrusion 42) of the left and right side walls 41, respectively. The inner side walls 41 (the right inner wall 41 on the left lock release lever 40, and the left inner wall 41 on the right lock release lever 40) are provided with forward extensions 45 which respectively extend further forward than the outer side walls (the left inner wall 41 on the left lock release lever 40, and the right inner wall 41 on the right lock release lever 40). Furthermore, an upper extension 45a which extends obliquely forward and upward is provided on the front end of each forward extension 45. A sideward extension 46, which extends horizontally in an inward direction is provided on an upper edge portion of the upper extension 45a, and a downward projection (connecting end portion) 47 is provided on a side-edge portion of the sideward extension 46 and extends downward therefrom. The upper and lower edge portions of the front part of the downward projection 47 are provided with rotational-movement restriction portions 48, respectively, which extend inwardly in a horizontal direction. Furthermore, a screw through-hole 49 is formed through each downward projection 47.

The lock spring 50 is a bilaterally-symmetrical member formed by bending a metal wire rod. A pair of front and rear locking portions (locking mechanism) 51 which extend substantially horizontally outwards are formed on portions of both left and right side portions of the lock spring 50 which are positioned slightly behind central portions thereof in the longitudinal direction, respectively. The part of the lock spring 50 (except the rear end portion thereof) that is positioned behind the locking portions 51 is substantially horizontal when in a free state, and the part of the lock spring 50 that is positioned in front of the locking portions 51 is substantially horizontal when in a free state. The lock spring 50 is provided at the front end thereof with a pair of left and right front-end locking lugs 52 which project outwardly in a substantially horizontal direction, and the rear-end portion of the lock spring 50 constitutes a rear-end lock-engaging portion 53, which is inclined upwardly in a side elevational view.

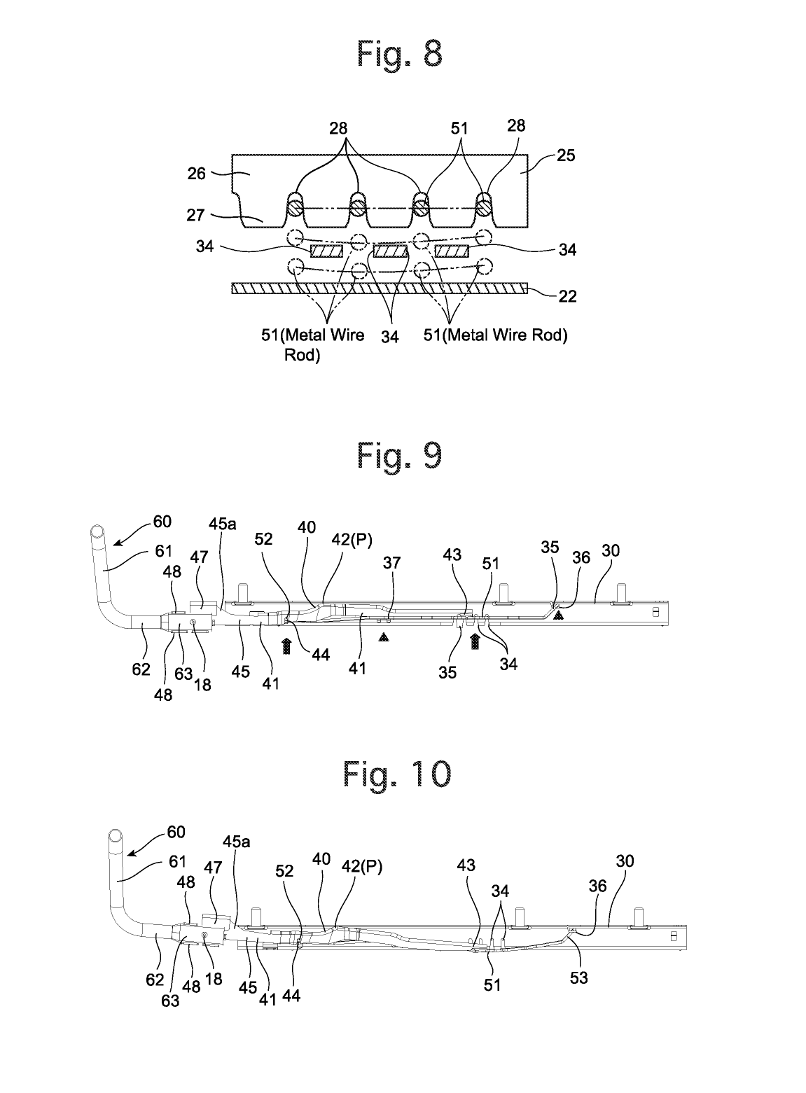

The lock release lever 40 is accommodated in the internal space of the associated upper rail 30 from the front end opening thereof (between the front end portion of the base 31 and the lower support portions 38), and the rotational contact protrusion 42 is in contact with a roof undersurface of the base 31 (see a contact portion “P” in FIGS. 9 and 10. Spaces are formed between the upper surface of the lock release lever 40 except the rotational contact protrusion 42 and a roof undersurface of the base 31). As shown in FIGS. 6, 7, 9 and FIG. 10, in the lock spring 50, the rear-end lock-engaging portion 53 is lock-engaged with the lock-engaging lug 36 (see the triangular mark in FIG. 9), the portions of the lock spring 50 that are positioned slightly forward from the left and right locking portions 51 are respectively lock-engaged with the left and right lock-engaging lugs 37 (see the triangular mark in FIG. 9), each locking portion 51 is engaged with an associated forward/rearward movement restriction groove 34 from below, and furthermore, the left and right front-end locking lugs 52 are lock-engaged with the spring-hook grooves 44 from below, and the spring pressing-pieces 43 come in contact with the upper surface of the portion of the lock spring 50 positioned between the pair of locking portions 51 from above. Upon assembling the lock spring 50 into the upper rail 30 and the lock release lever 40 in the above-described manner, the lock spring 50 is movable relative to the upper rail 30 in the forward/rearward direction within a minute range while the lock-engagement of the rear-end lock-engaging portion 53 of the lock spring 50 with the lock-engaging lug 36 is not released, and with the lock-engagement between the front-end locking lugs 52 and the spring-hook grooves 44 being maintained. In addition, the lock spring 50 produces an upward biasing force (elastic force) by being elastically deformed (see arrows ↑ shown in FIG. 9), and accordingly, this biasing force causes the rotational contact protrusion 42 of the lock release lever 40 to be pressed against the roof underside portion of the base 31, which allows the lock release lever 40 to rotate about the rotational contact protrusion 42 (about an imaginary rotation axis in the leftward/rightward direction) about the contact portion P between the roof underside portion and the rotational contact protrusion 42, and the lock release lever 40 is held in the locked position shown in FIG. 9 when no upward external force is exerted on the front end portion of the lock release lever 40. On the other hand, exerting an upward external force on the front end portion of the lock release lever 40 against the biasing force of the lock spring 50 causes the lock release lever 40 to rotate to the unlocked position shown in FIG. 10. Thereupon, since the spring pressing-pieces 43 of the lock release lever 40 downwardly depress the portions of the lock spring 50 which are positioned between the pair of locking portions 51, each locking portion 51 escapes downward from the associated lock groove 28 (see the locking portions 51 indicated with the imaginary lines shown in FIG. 8).

Furthermore, upon the integration of the upper rail 30, the lock release lever 40 and the lock spring 50, the forward extension 45, the sideward extension 46 and the downward projection 47 of the lock release lever 40 are positioned forward from the upper rail 30. Furthermore, as shown in FIGS. 6 and 7, etc., the section of the sideward extension 46 that is positioned toward the downward projection 47 from the central portion of the sideward extension 46, and the downward projection 47, are positioned to one side of the upper rail 30 in a front elevational view.

An assembly made by inserting an upper rail 30, a lock release lever 40 and a lock spring 50, which are integrated in the above described manner, into one lower rail 21 from the front end opening or rear end opening of the lower rail 21 constitutes a rail unit 20. When a rail unit 20 is assembled, the upright walls 32 and the locking walls 33 of the upper rail 30 enter the spaces formed between the outer wall portions 23 and the inner wall portions 25 as shown in FIG. 4 (the locking walls 33 are omitted in FIG. 4), and a plurality of bearing balls 56 which are rotatably supported by retainers 55 installed in the aforementioned spaces are in rotatable contact with both outer surfaces of the upright walls 32 and inner surfaces of the outer wall portions 23, which allow the upper rail 30 (and the lock release lever 40 and the lock spring 50) to slide in the forward/rearward direction with respect to the lower rail 21. Furthermore, since a front-end stopper and a rear-end stopper, which are omitted from the drawings, are provided between the upper rail 30 and the lower rail 21, each upper rail 30 is slidable relative to the lower rail 21 between a front-end position (not shown) and a rear-end position (the position shown in FIG. 1).

Furthermore, upon assembling the rail unit 20, the forward extension 45 (upper extension 45a) of the lock release lever 40 is positioned on the inner side of an associated inner wall portion 25 and an associated base-end supporting portion 26 (and is parallel to the inner wall portion 25), the sideward extension 46 is positioned directly above an associated roof underside portion 24, and the downward projection 47 is positioned on the outer side of an associated outer wall portion 23 (and is parallel to the outer wall portion 23), as shown in FIGS. 1 and 6, etc.

In addition, when the lock release lever 40 is in the locked position, the upper rail 30 is prevented from sliding with respect to the lower rail 21 because each locking portion 51 is engaged with the associated forward/rearward movement restriction groove 34 and lock groove 28 from below as shown by solid lines in FIG. 8. On the other hand, rotating the lock release lever 40 down to the unlocked position causes each locking portion 51 which is engaged with some of the lock grooves 28 to be disengaged downward therefrom as shown by the phantom lines in FIG. 8, which allows the upper rail 30 to slide with respect to the lower rail 21.

The pair of left and right rail units 20 thus assembled are made to be parallel to each other and the positions thereof in the forward/rearward direction are made to coincide with each other (the sliding positions of the upper rails 30 with respect to the lower rails 21 are also made to coincide with each other); thereafter, a seating portion of a seat (not shown) is mounted onto the upper surfaces of the upper rails 30.

After the left and right rail units 20 and the seat 11 are integrated in this manner, the loop handle 60 is connected to the left and right lock release levers 40.

The loop handle 60 is made by bending a metal pipe member, and is provided with an operation portion 61 which extends in the leftward/rightward direction, a pair of oblique portions extending obliquely rearwardly downward from both left and right ends of the operation portion 61, and a pair of rear-end connecting portions 62 which respectively extend rearwardly from both left and right ends of the oblique portions. The rear end portion of each rear-end connecting portions 62 constitutes a flat-plate portion 63, and each flat-plate portion 63 is provided with a female screw-hole 64.

The left and right rear-end connecting portions 62 of the loop handle 60 are attached to the left and right lock release levers 40, respectively, by inserting, from the front end, each flat-plate portion 63 in between the upper and lower rotational-movement restriction portions 48 of the downward projection 47 of each of the left and right lock release levers 40, and screw-engaging a screw 18 that is inserted through the screw through-hole 49 from the outer side (the right side of the right lock release lever 40 and the left side of the left lock release lever 40) into the female screw-hole 64 of the corresponding flat-plate portion 63. Upon attaching the flat-plate portions 63 to the downward projections 47, respectively, in the above-described manner, since the both of the upper and lower surfaces of the flat-plate portion 63 respectively contact the upper and lower rotational-movement restriction portions 48, each flat-plate portion 63 (and hence, the loop handle 60) becomes fixed relative to the corresponding downward projection 47 (lock release lever 40) since rotation of the flat-plate portion 63 (loop handle 60) is restricted relative to the downward projection 47, centered about the screw 18.

An assembled slide rail device 10 is attached to the vehicle interior floor using a pair of front and rear bolts 15. Namely, a threaded section 16 of each bolt 15 is inserted, from above (from the internal space of the lower rail 21), into a pair of front and rear bolt through-holes 22a formed in the bottom wall 22, the front and rear threaded sections 16 are screw-engaged with the corresponding female threaded holes (in, e.g., a welded nut) that are provided in the vehicle floor, and the underside of a head 17 of each bolt 15 is pressure-welded onto the upper surface of the bottom wall 22.

Upon an occupant, sitting down with the slide rail device 10 mounted onto the vehicle floor, grasping the operation portion 61 by hand and rotating the entire loop handle 60 upwards, this rotational force is transmitted from the rear-end connecting portions 62 (the flat-plate portions 63) to the downward projections 47 of the lock release levers 40, respectively, so that the lock release levers 40 rotate upwardly with the rear-end connecting portions 62 (the flat-plate portions 63). Accordingly, since the lock release levers 40 that were positioned at the locked position rotate to the unlocked position, the upper rails 30, which were restricted from sliding relative to the lower rail 21, become slidable relative to the lower rails 21.

In the slide rail device 10 of the present invention, the forward extension 45 of the inner side walls 41, the sideward extension 46 and the downward projection 47 are positioned forward from the front end of the upper rail 30, and each downward projection 47, which is a portion that connects with the loop handle 60, is positioned at one side of the side walls 21a (the outer wall portions 23, the roof underside portions 24 and the inner wall portions 25) of each lower rail 21.

Accordingly, when the upper rails 30 are slidably moved along the lower rails 21 in the forward/rearward direction, there is no risk of the loop handle 60 (flat-plate portions 63) or the front ends of the lock release levers 40 contacting the bolts 15 (heads 17) that are positioned on the bottom wall 22 of each lower rail 21. Note that, as shown in FIG. 4, when the lock release lever 40 is positioned at the locked position, although the lower end of the forward extension 45 of the lock release lever 40 and the lower end of the part of the lock release lever 40 that is positioned behind the forward extension 45 are positioned lower than the upper edges of the heads 17 (of the bolts 15), since the heads 17 are positioned in between the left and right side walls 41, there is no risk of the forward extension 45 of the lock release lever 40 and the part of the lock release lever 40 that is positioned behind the forward extension 45 contacting the bolts 15 (heads 17) when the upper rail 30 is slidably moved relative to the lower rail 21 in the forward/rearward direction.

The locking/unlocking operation that is carried out by the loop handle 60 and the lock release levers 40 can be made secure and reliable by setting a large rotational range (the rotational angle for rotating the lock release levers 40 between the locked position and the unlocked position) for the loop handle 60 and the lock release levers 40. In the slide rail device 10 of the present invention, since there is no risk of the loop handle 60 (flat-plate portions 63) contacting the bottom walls 22 of the lower rails 21, even if the rotational range of the lock release levers 40 is set to a large rotational angle, a secure and reliable locking/unlocking operation can be achieved.

Furthermore, since there is no need to form a through-hole through the upper rails 30 (through which the lock release levers 40 would respectively extend), the mechanical strength of the upper rails 30 is not reduced.

In addition, the front end portion of each lock release lever 40 has a structure which includes the forward extension 45 (upper extension 45a), which faces and extends parallel to one of the inner wall portions 25 on the inner side of the inner wall portion 25 and corresponding base-end supporting portion 26, the sideward extension 46 positioned directly above the corresponding roof underside portion 24, and the downward projection 47 which faces and extends parallel to a corresponding outer wall portion 23, on the outer side thereof; therefore, it is possible to significantly reduce the upward/downward and leftward/rightward dimensions of the front end portion of each lock release lever 40. Accordingly, it is possible to reduce the risk of the front end portion of each lock release lever 40 coming in contact with obstacles positioned in between the left and right rail units 20.

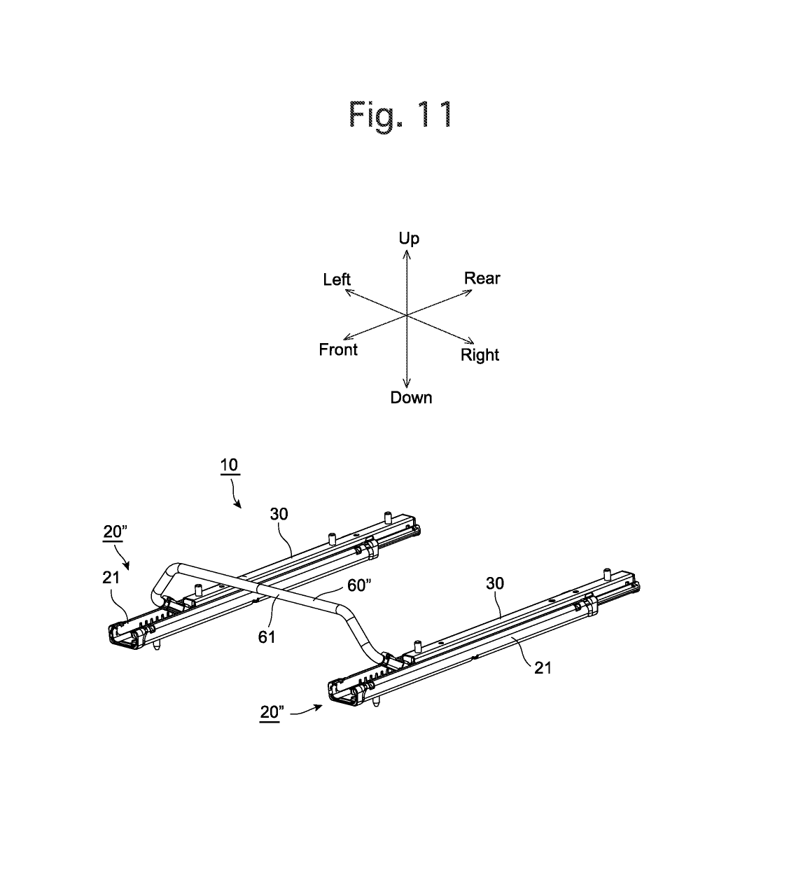

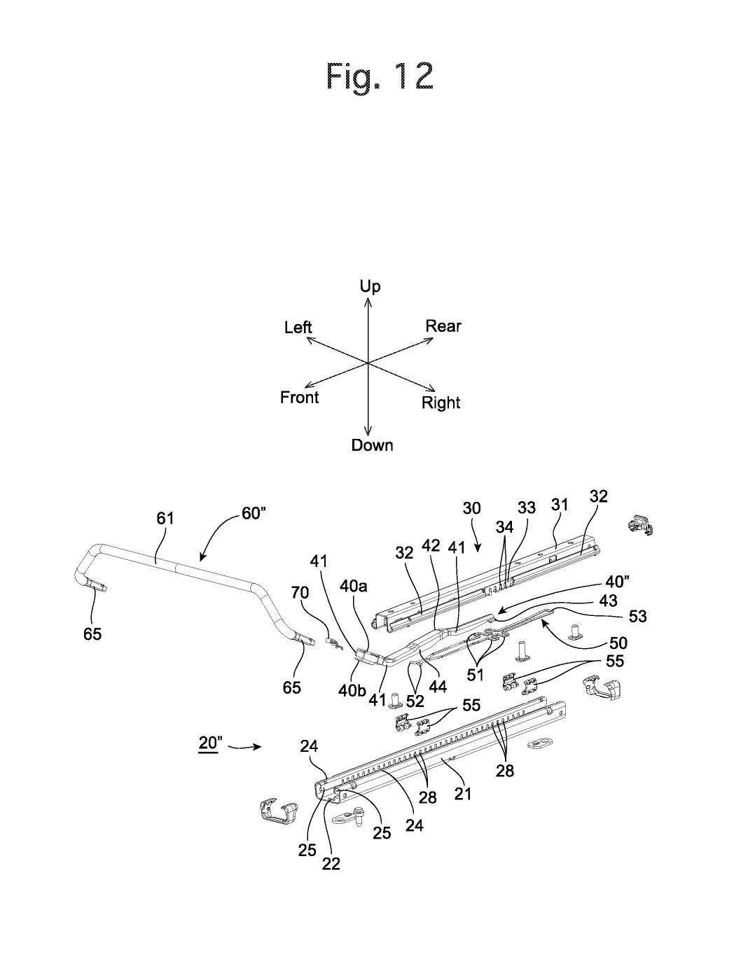

Next, a second embodiment of the present invention will be described while referring to FIGS. 11 through 15. Members that are the same as those in the first embodiment are designated with the same designators, and detailed descriptions thereof have been omitted.

In a rail unit 20′ of the second embodiment, the shapes of the lock release lever 40″ and the loop handle 60″ are different to those of the lock release lever 40 and the loop handle 60 of the first embodiment, and a handle connecting spring 70 is further provided.

A handle attachment portion (connection end) 40a, which extends obliquely upward in a forward direction, is formed on the front end portion of the lock release lever 40″ (the lock release lever 40″ has substantially the same shape as that of the lock release lever 40 except for the handle attachment portion 40a). The left and right side walls 41 of the lock release lever 40″ extend to the front end portion of the lock release lever 40″. The lower edge of a front end portion of one of the side walls 41 of the lock release lever 40″ is provided with a base-plate portion 40b, which extends toward the other of the side walls 41. Hence, the handle attachment portion 40a has a shape of a substantially rectangular tube.

The loop handle 60″ is provided with a pair of left and right upper rear-end connecting portions 65 which respectively extend rearwardly from the left and right inclined portions. As shown in the drawings, the rear-end connecting portions 65 has a shape of a substantially rectangular tube.

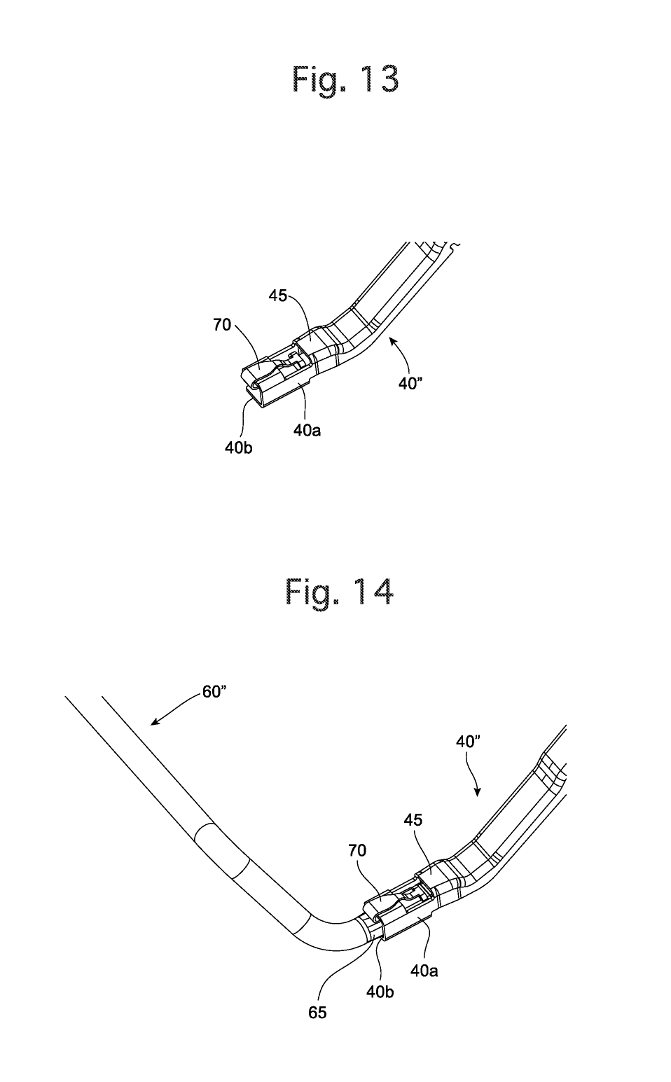

The handle connecting spring 70, which is formed from a spring plate, is fixedly attachable to the roof underside portion of the handle attachment portion 40a (see FIG. 13). Furthermore, after fixing the handle connecting springs 70 to each respective handle attachment portion 40a, the left and right rear-end connecting portions 65 of the loop handle 60 are inserted into the left and right handle attachment portions 40a through the front-end openings thereof, respectively. Thereupon, since an engaging projection of each of the handle connecting springs 70 engages with an associated recess formed in each of the left and right rear-end connecting portions 65, the left and right rear-end connecting portions 65 are connected with the left and right handle attachment portion 40a via the handle connecting springs 70, respectively.

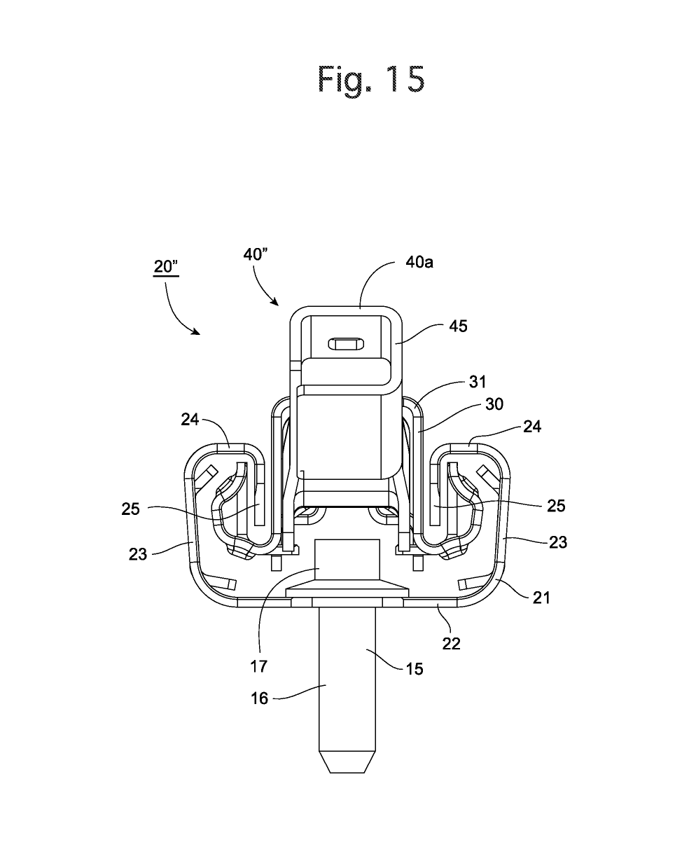

Upon integrating the upper rail 30, the lock release lever 40″ and the lock spring 50 in the same manner as described in the first embodiment, the handle attachment portion 40a of the lock release lever 40″ is positioned further forward from the front end of the upper rail 30. Furthermore, as shown in FIG. 15, when the lock release lever 40″ is positioned at the locked position (and also when the lock release lever 40″ is positioned at the unlocked position), the upper edge of the front end portion of the handle attachment portion 40a is positioned further upward than the upper end surface of the upper rail 30.

Furthermore, upon assembling the rail unit 20″ in the same manner as described in the first embodiment, the lower edge of the front end portion of the handle attachment portion 40a is positioned further upward than the upper end surface of the lower rail 21 when the lock release lever 40″ is positioned at the locked position (and also when the lock release lever 40″ is positioned at the unlocked position), as shown in FIG. 15.

In each rail unit 20″ of the second embodiment, since the rear-end connecting portions 65 of the loop handle 60 are connected to the handle attachment portion 40a of the lock release lever 40″, when the upper rail 30 is slidably moved in the forward/rearward direction relative to the lower rail 21, there is no risk of the loop handle 60″ (rear-end connecting portions 65) and the handle attachment portion 40a of each lock release lever 40 contacting the bolts 15 (heads 17) that are provided on the bottom wall 22 of each lower rail 21. Note that, as shown in FIG. 15, when the lock release lever 40″ is positioned at the locked position, although the lower end of the section of the lock release lever 40″ that is positioned further rearward from the handle attachment portion 40a is positioned lower than the top ends of the heads 17 of the bolts 15, since each head 17 is positioned in between the left and right side walls 41, when the upper rails 30 are slidably moved in the forward/rearward direction relative to the lower rails 21, there is no risk of the section of the lock release lever 40″ that is positioned further rearward from the handle attachment portion 40a contacting the bolts 15 (heads 17).

Furthermore, since the handle attachment portion 40a of the lock release lever 40″ extends upward in forwardly oblique direction, even if the rotational range of the loop handle 60″ and the lock release lever 40″ is set to a large angle, there is no risk of the loop handle 60 (rear-end connecting portions 65) and the handle attachment portion 40a of the lock release lever 40″ contacting the bottom wall 22 of each lower rail 21. Accordingly, a secure and reliable locking/unlocking operation can be achieved.

Furthermore, since the rail units 20 of the second embodiment also do not need a through-hole formed through each upper rail 30 (through which the lock release levers 40 would respectively extend), the mechanical strength of the upper rails 30 is not reduced.

Obvious changes may be made in the specific embodiments of the present invention described herein, such modifications being within the spirit and scope of the invention claimed. It is indicated that all matter contained herein is illustrative and does not limit the scope of the present invention.

What is claimed:

1. A slide rail device for a vehicle comprising:
a lower rail which extends in a forward/rearward direction and is formed as a channel member that is open at the upper side thereof, said lower rail being immovable relative to a floor of the vehicle;
an upper rail which is formed as a channel member that is open at the lower side thereof, said upper rail being supported by said lower rail to be slidably movable relative to said lower rail in said forward/rearward direction;
a locking mechanism provided between said upper rail and said lower rail, wherein said locking mechanism one of restricts and releases a restriction of a sliding movement of said upper rail relative to said lower rail;
a lock release lever, provided in an internal space of said upper rail, which is upwardly/downwardly rotatable between a locked position at which said locking mechanism is allowed to restrict the slidable movement of said upper rail relative to said lower rail, and an unlocked position at which the restriction of said slidable movement of said upper rail relative to said lower rail is released, wherein a front end portion of said lock release lever is positioned further forward than a front end of said upper rail;
a connecting end portion formed on said front end portion of said lock release lever, wherein said connecting end portion is positioned one of above a portion of said lock release lever that is in said internal space of said upper rail and at one side of said lower rail; and
a handle, wherein an end portion of which is connected to said connecting end portion.

2. The slide rail device for a vehicle according to claim 1, wherein at least part of said connecting end portion that is positioned above a portion of said lock release lever that is in said internal space of said upper rail is positioned above an upper surface of said lower rail.

3. The slide rail device for a vehicle according to claim 1, wherein said front end portion of said lock release lever comprises:
an upper extension which extends upwardly along an inner surface of one side wall of said lower rail;
a sideward extension which extends in a sideward direction from an upper end of said upward extension and is positioned directly above said one side wall; and
said connecting end portion, said connecting end portion extending downwardly from an end portion of said sideward extension along an outer surface of said one side wall.

4. The slide rail device for a vehicle according to claim 1, wherein said lock release lever is an integrally molded member.
